(19) United States
(12) Patent Application Publication
(10) Pub. No.: US 2025/0252715 A1
(43) Pub. Date: Aug. 7, 2025

(54) SYSTEM FOR AUTOMATED DATA COLLECTION AND ANNOTATION OF STORE ITEMS AT THE POINT OF SALE

(71) Applicant: Synaptics Incorporated, San Jose, CA (US)

(72) Inventors: Deepak Mital, San Jose, CA (US); Karthikeyan Shanmuga Vadivel, San Jose, CA (US); Manjunath Duntoor, Fremont, CA (US)

(73) Assignee: Synaptics Incorporated, San Jose, CA (US)

(21) Appl. No.: 19/041,356

(22) Filed: Jan. 30, 2025

Related U.S. Application Data
(60) Provisional application No. 63/548,728, filed on Feb. 1, 2024.

(51) Int. Cl. G06V 10/774; G06Q 20/20; G06V 10/764

(52) U.S. Cl. CPC G06V 10/774; G06Q 20/208; G06V 10/764

(57) ABSTRACT

This disclosure provides methods, devices, and systems for computer vision. The present implementations more specifically relate to automated data collection and annotation of store items at the point of sale. In some implementations, a computer vision system may capture one or more images of an object via one or more cameras each having a field of view (FOV) that encompasses a sensing region of a checkout counter; receive information about the object from a point of sale (POS) system associated with the sensing region, the information including at least a price of the object; and training the computer vision model to classify objects in the sensing region of the checkout counter based on the one or more images captured via the one or more cameras and the information received from the POS system.

### CROSS-REFERENCE TO RELATED APPLICATIONS

This application claims the benefit of U.S. Provisional Application No. 63/548,728, titled “System for Automated Data Collection and Annotation of Store Items at the Point of Sale” and filed on Feb. 1, 2024, which is incorporated by reference herein in its entirety.

### TECHNICAL FIELD

The present implementations relate generally to computer vision, and specifically to a system for automated data collection and annotation of store items at the point of sale.

### BACKGROUND OF RELATED ART

Computer vision is a field of artificial intelligence (AI) that mimics the human visual system to draw inferences about an environment from images or video of the environment. Example computer vision technologies include object detection, object classification, and object tracking, among other examples. Some computer vision systems rely on machine learning for object classification. Machine learning is a technique for improving the ability of a computer system or application to perform a specific task. During a “training” phase, a machine learning system (such as a neural network) is provided with one or more “answers” and a large volume of raw training data associated with the answers. The machine learning system analyzes the training data to learn a set of rules (also referred to as a “model”) that can be used to describe each of the one or more answers. During an “inferencing” phase, a computer vision application may infer answers from new data using the machine learning model.

Data annotation is the process of tagging or labeling training data to provide context for the training operation. For example, when training a machine learning model to identify a particular object (or class of objects) in images, the machine learning system may be provided a large volume of input images depicting the object. Each of the input images may be annotated to ensure that the machine learning system can learn a set of features that uniquely describes the target object to the exclusion of any other objects having a different classification. Example suitable annotations may include, among other examples, a bounding box surrounding the target object (or objects) in each of the input images or contextual information labeling or identifying the target object (or objects) in each of the input images.

Existing data annotation techniques rely on human operators to review and annotate each input image (or other training data) to be used for training. Due to the large volume of input images required for training, human operators may require hundreds of hours (if not longer) to construct an annotated set of input images. Thus, there is a need for annotating training data more efficiently.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method for training a computer vision model. The method includes capturing one or more images of an object via one or more cameras each having a field of view (FOV) that encompasses a sensing region of a checkout counter; receiving information about the object from a point of sale (POS) system associated with the sensing region, the information including at least a price of the object; and training the computer vision model to classify objects in the sensing region of the checkout counter based on the one or more images captured via the one or more cameras and the information received from the POS system.

Another innovative aspect of the subject matter of this disclosure can be implemented in a computing vision system, which includes one or more processors, a memory coupled to the one or more processors, and one or more cameras, each camera having a field of view (FOV) that encompasses a sensing region of a checkout counter. The memory stores instructions that, when executed by the one or more processors, cause the computer vision system to capture one or more images of an object via the one or more cameras; receive information about the object from a point of sale (POS) system associated with the sensing region, the information including at least a price of the object; and train a computer vision model to classify objects in the sensing region of the checkout counter based on the one or more images captured via the one or more cameras and the information received from the POS system.

### BRIEF DESCRIPTION OF THE DRAWINGS

The present embodiments are illustrated by way of example and are not intended to be limited by the figures of the accompanying drawings.

FIG. 1 shows an example environment in which computer vision may be implemented.

FIG. 2 shows a block diagram of an example computer vision system, according to some implementations.

FIG. 3 shows a block diagram of an example point of sale (POS) system, according to some implementations.

FIG. 4 shows another block diagram of an example POS system, according to some implementations.

FIG. 5 shows an illustrative flowchart depicting an example operation for training a computer vision model, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random-access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, computer vision is a field of artificial intelligence (AI) that mimics the human visual system to draw inferences from images or video of an environment. Computer vision can improve the speed and accuracy of many routines or processes that currently require a significant amount of human interaction. For example, when checking out items at a store or library, a human operator (such as a cashier or customer) currently scans each item using a barcode scanner or enters an item code into a point of sale (POS) system to complete a purchase or transaction. As such, the existing checkout process may provide a poor customer experience and may even cause the merchant to lose money as a result of human error or fraud. Aspects of the present disclosure recognize that computer vision can improve the checkout process by using trained models to classify or recognize items at a checkout counter with little or no involvement by the customer (or cashier).

However, existing data annotation techniques rely on human operators to review and annotate each input image used for training a computer vision model, which can be a significant barrier to adoption for many computer vision applications. Data annotation is the process of tagging or labeling training data that is required for training machine learning models to be used in computer vision applications. For example, when training a machine learning model to identify a particular object (or class of objects) in images, the machine learning system may be provided a large volume of input images depicting the object. Each of the input images is annotated to ensure that the machine learning system can learn a set of features that uniquely describes the target object to the exclusion of any other objects having a different classification. Aspects of the present disclosure recognize that legacy POS systems at existing checkout counters can be used to collect and annotate data for training and updating a computer vision model in a manner transparent to the human operator.

Various aspects relate generally to computer vision, and more particularly, to techniques for automating the annotation of data for training computer vision models. In some aspects, a computer vision system may include one or more cameras configured to capture images of objects in a sensing region of a checkout counter; a POS system configured to acquire information about the objects in the sensing region; and a computer vision system configured to train a computer vision model for classifying objects in the sensing region based on the images captured via the one or more cameras and the information acquired via the POS system. More specifically, the computer vision system may annotate the images for training purposes using the information about the objects contained therein. The information acquired by the POS system may include any information that can be used to match the objects to items in an inventory database (e.g., with pricing information). Example suitable information may include, among other examples, a Universal Product Code (UPC) acquired via a barcode scanner associated with the POS system or a Price Look Up (PLU) code input by a user of the POS system.

Particular implementations of the subject matter described in this disclosure can be implemented to realize one or more of the following potential advantages. By leveraging the information acquired by existing POS systems when processing customer transactions, aspects of the present disclosure can substantially automate the process of annotating data for training a computer vision model. For example, a cashier or customer can use a legacy POS system to check out items at a store or library while the computer vision system programmatically annotates a large volume of input images using the information acquired during the checkout process. More specifically, the data annotation can be performed without any knowledge or input by the human operator of the POS system (beyond using the POS system in a conventional manner, such as by scanning a barcode or inputting a PLU code). In contrast with existing data annotation techniques, which require a human operator to manually annotate each input image, the data annotation techniques of the present disclosure can substantially reduce the time and cost associated with training computer vision models and enable new computer vision applications.

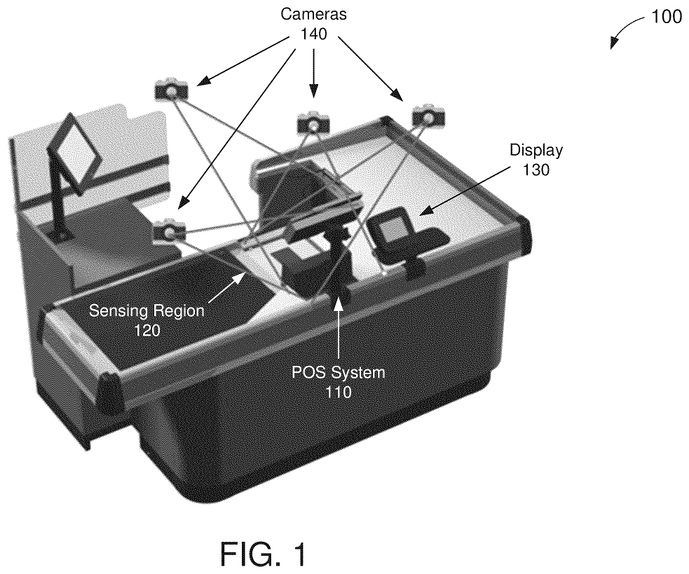

FIG. 1 shows an example environment 100 in which computer vision may be implemented. In some aspects, the example environment 100 may be a store, library, or other retail or rental facility. As shown in FIG. 1, the example environment 100 includes a checkout counter having a point of sale (POS) system 110, a sensing region 120, a display 130, and one or more cameras 140. More specifically, the checkout counter may be used to process transactions between a customer and a merchant.

In some implementations, the checkout counter may be operated by a cashier or employee of the merchant. In some other implementations, the checkout counter may be operated by the customer (also referred to as a “self-check-out counter”). When checking out items, the cashier or customer places each item in the sensing region 120 to be scanned or otherwise processed by the POS system 110 for purchase or rent. The POS system 110 is configured to look up each item placed in the sensing region 120, in an inventory database associated with the merchant, and produce an itemized list (with associated costs and/or other information) to be presented to the customer via the display 130. Thus, the POS system 110 may include one or more components for determining the types of items in the sensing region 120. Example suitable components may include barcode readers, scales, keypads, and keyboards, among other examples.

In some implementations, the POS system 110 may determine the types of items in the sensing region 120 based on images captured via the cameras 140. As shown in FIG. 1, each of the cameras 140 has a field of view (depicted as a pair of lines extending from each camera 140 to the sensing region 120) that encompasses the sensing region 120 from a respective angle. As such, the cameras 140 may capture images of objects in the sensing region 120 from different angles. In some implementations, the POS system 110 may implement one or more machine learning models (also referred to as “computer vision models”) to classify the objects in the captured images. For example, the POS system 110 may use the computer vision models to match the objects in the captured images to items in the merchant's inventory database.

Aspects of the present disclosure recognize that computer vision may significantly enhance the performance of the POS system 110 as well as the customer experience during checkout. For example, at existing checkout counters, a human operator is often required to place one item at a time in the sensing region 120 to be checked out via the POS system 110. By contrast, a computer vision model can be trained to identify multiple items of varying types placed together in the sensing region 120, which can significantly reduce customer wait times at checkout counters. Existing POS technologies are also susceptible to human error or fraud (such as misaligned, damaged, or replaced barcodes, or incorrect product look up (PLU) codes). However, computer vision models can be trained to recognize items very accurately based solely on their appearance, rather than rely on labels (such as barcodes or PLU codes) that can be modified or spoofed.

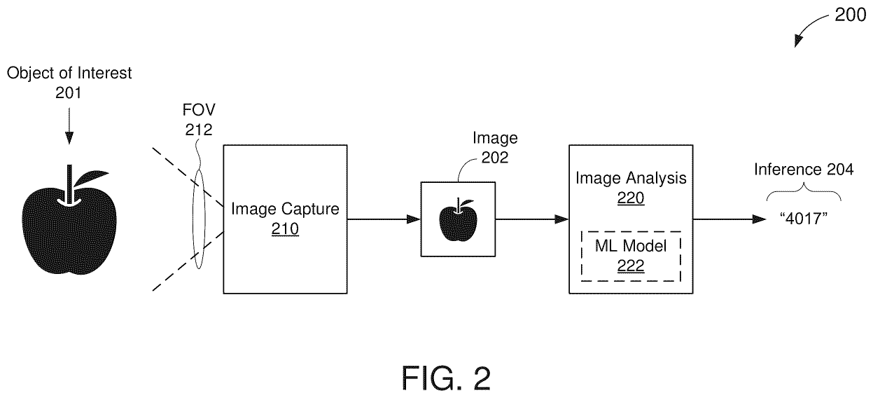

FIG. 2 shows a block diagram of an example computer vision system 200, according to some implementations. In some implementations, the computer vision system 200 may be one example of the checkout counter of FIG. 1. More specifically, the computer vision system 200 may be configured to generate inferences 204 about one or more objects of interest 201. In some implementations, an object of interest 201 may include one or more items in a merchant's inventory database. In the example of FIG. 2, an object of interest 201 is depicted as an apple. However, the computer vision system 200 may be trained to generate inferences about various other objects of interest in addition to, or in lieu of, the object of interest 201 depicted in FIG. 2.

The computer vision system 200 includes an image capture component 210 and an image analysis component 220. The image capture component 210 may be any sensor or device (such as a camera) configured to capture a pattern of light in its FOV 212 and convert the pattern of light to a digital image 202. With reference to FIG. 1, the image capture component 210 may be one example of any of the cameras 140. The digital image 202 may include an array of pixel values representing the pattern of light in the FOV 212 of the image capture component 210. In some implementations, the image capture component 210 may continuously (or periodically) capture a series of digital images 202 representing a digital video. As shown in FIG. 2, the object of interest 201 is located within the FOV 212 of the image capture component 210 so that the digital images 202 include the object of interest 201. With reference to FIG. 1, the FOV 212 may coincide with the sensing region 120 of the checkout counter.

The image analysis component 220 is configured to produce one or more inferences 204 based on the digital image 202. With reference to FIG. 1, the image analysis component 220 may be one example of the POS system 110. In some aspects, the image analysis component 220 may classify the object of interest 201 into one or more item types. For example, the image analysis component 220 may determine which (if any) types of items in an inventory database match the object of interest 201. In other words, the image analysis component 220 may produce an inventory identifier (such as “4017”), as the inference 204, that can be used to look up the item in the inventory database. In some implementations, the object of interest 201 may include a bag or container storing multiple items or items of various types. Thus, the image analysis component 220 may be configured to produce a respective inventory identifier (ID) for each item associated with the object of interest 201.

In some implementations, the image analysis component 220 may produce the inference 204 based on a machine learning (ML) model 222. Machine learning is a technique for improving the ability of a computer system or application to perform a certain task. During a training phase, a machine learning system may be provided with multiple “answers” and one or more sets of raw data to be mapped to each answer. For example, a machine learning system may be trained to recognize various items associated with an inventory database by providing the machine learning system with a large number of images depicting each item (which represents the raw data) and label information indicating the type of item, or inventory ID associated with the item, in each image (which represents the answers).

The machine learning system analyzes the raw data to “learn” a set of rules that can be used to identify (or classify) the same items in other images. For example, the machine learning system may perform statistical analysis on the raw data to determine a common set of features (also referred to as a set of “rules”) that is unique to each item in the inventory database. As such, the ML model 222 may include a set of rules that can be used to classify each object of interest 201 according to various item types associated with an inventory database. In some implementations, the ML model 222 may be a neural network model.

In some aspects, data annotations may help guide the machine learning system to train a robust and accurate ML model 222. Data annotation is the process of tagging or labeling training data, which is a requirement for the training operation. For example, each of the input images may be annotated to ensure that the machine learning system can learn a set of features that uniquely describes a particular inventory item to the exclusion of any other items associated with the inventory database. Example suitable annotations may include, among other examples, Universal Product Codes (UPCs), Price Look Up (PLU) codes, item weights, or any other labels or identifiers used by a merchant for cataloging items in the merchant's inventory database.

Existing data annotation techniques rely on human operators to review and annotate each input image in a training set provided to a machine learning system. However, as described above, the machine learning system may require a large volume of input images to train a robust and accurate ML model. Moreover, each input image in a training set may depict a particular inventory item at a different distance, angle, location, or under different lighting conditions. As a result, human operators may require hundreds of hours (if not longer) to annotate each input image in a given training set. However, aspects of the present disclosure recognize that legacy POS systems used at existing checkout counters include various components or features that can be used to collect and annotate data for training purposes in a manner that is transparent to the human operator.

As described with reference to FIG. 1, when checking out items at a checkout counter, a cashier or customer (also referred to more generally as the “operator”) places each item in the sensing region 120, one-by-one, to be scanned or otherwise processed by the POS system 110. Many items include barcodes carrying identifying information (such as UPC codes) that can be scanned or otherwise read by a barcode scanner associated with the POS system 110. Items that do not have barcodes (such as fruits, vegetables, or other fresh produce) are often affixed with labels having identifying information printed thereon (such as PLU codes) that can be manually input into the POS system 110 via a keypad or other user interface (UI) feature. Some items may be purchased in bulk based on the total weight of the items, as measured by a scale associated with the POS system 110.

As shown in FIG. 1, the cameras 140 may capture images of items in the sensing region 120 while such items are scanned or otherwise processed using legacy POS technologies (such as barcode scanners, scales, keypads, or other UI features). In some aspects, the POS system 110 may annotate the images captured via the cameras 140 based on any information concurrently acquired by the POS system 110 using one or more legacy POS technologies. In some implementations, the annotations may include barcode data (such as UPC codes) acquired via a barcode scanner associated with the POS system 110. In some other implementations, the annotations may include item codes (such as PLU codes) keyed in by an operator of the POS system 110. Still further, in some implementations, the annotations may include item weights measured by a scale associated with the POS system 110.

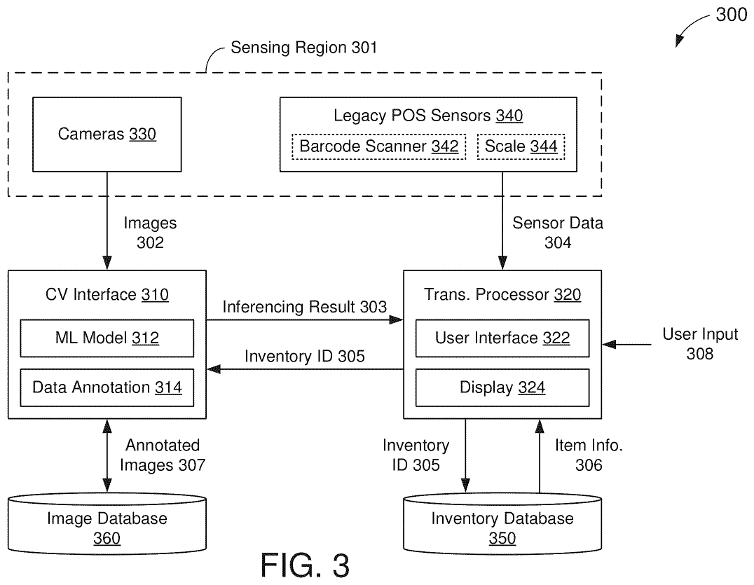

FIG. 3 shows a block diagram of an example POS system 300, according to some implementations. In some implementations, the POS system 300 may be one example of the checkout counter of FIG. 1 or the computer vision system 200 of FIG. 2. More specifically, the POS system 300 may be configured to process transactions between a merchant and customer. Such transactions may include checking out items placed in a sensing region 301 of a checkout counter (such as the sensing region 120 of FIG. 1).

The POS system 300 includes a computer vision (CV) interface 310, a transaction processing component or transaction processor 320, one or more cameras 330, and one or more legacy POS sensors 340. The cameras 330 are configured to capture images 302 of objects (or items) in the sensing region 301. The CV interface 310 is configured to produce inferences about the objects in the captured images 302. The CV interface 310 includes a machine learning (ML) model 312 and a data annotation component 314. In some implementations, the ML model 312 may be one example of the ML model 222 of FIG. 2. Thus, the inferences derived from the images 302 may include an inventory ID 305 that uniquely identifies a particular item in an inventory database 350.

In some implementations, the CV interface 310 may provide the inventory ID 305, as an inferencing result 303, to the transaction processor 320. The transaction processor 320 includes a user interface 322 and a display 324. The transaction processor 320 is configured to look up item information 306 associated with the inventory ID 305 (such as a description or price of the identified item) from the inventory database 350. In some implementations, the transaction processor 320 may display the item information 306 on the display 324. For example, the display 324 may present a listing of items identified in the sensing region 301 together with their associated prices. In some implementations, the transaction processor 320 may further receive user inputs 308 via the user interface 322 (such as confirmation or payment) to complete the transaction.

In some aspects, the CV interface 310 may be unable to identify or infer an inventory ID for one or more items in the images 302 (such as when the ML model 312 has not yet been trained or when a new item is added to the inventory database 350). In such aspects, the transaction processor 320 may rely on the user interface 322 and/or one or more legacy POS sensors 340 to determine the inventory IDs 305 for items in the sensing region 301. The user interface 322 is configured to receive item codes (such as PLU codes), as user inputs 308, from a human operator of the POS system 300 (such as a cashier or customer). Example suitable user interfaces 322 include virtual or physical keyboards and keypads, among other examples.

The legacy POS sensors 340 are configured to read or detect sensor data 304 from items in the sensing region 301. In some aspects, the legacy POS sensors 340 may include a barcode scanner 342 and a scale 344. The barcode scanner 342 is configured to scan or read barcodes (such as UPC codes) printed or affixed to items in the sensing region 301. Example suitable barcode scanners 342 include barcode scanners that are fixed or integrated with a portion of a checkout counter coinciding with the sensing region 301 or handheld barcode scanners that can be moved around by the operator of the POS system 300. The scale 344 is configured to measure a weight of the items in the sensing region 301. For example, the weight may be used to determine a price for the items or as a security measure to protect against fraud.

The transaction processor 320 is configured to determine an inventory ID 305 based on the sensor data 304 (such as item weight, UPC code, or other barcode information) and/or the user input 308 (such as PLU code or other item code) and use the inventory ID 305 to look up item information 306 in the inventory database 350. In some implementations, the inventory ID 305 may be or include the sensor data 304 and/or user input 308. In some aspects, the transaction processor 320 may further provide the inventory ID 305 (including the sensor data 304 and/or the user input 308) to the CV interface 310 for data annotation. The data annotation component 314 is configured to combine images 302 (e.g., images containing unknown items) with the inventory IDs 305 associated with such items to produce annotated images 307. In some implementations, the annotated images 307 may be stored in an image database 360.

In some implementations, the data annotation component 314 may annotate items individually. For example, items containing barcodes must be individually placed in the sensing region 301 (one-by-one) to be scanned by the barcode scanner 342. During this process, the cameras 330 may capture images 302 of a single item (or object of interest) and the transaction processor 320 may concurrently acquire an inventory ID 305 (such as a UPC code) for that item. The data annotation component 314 combines the images 302 with the inventory ID 305 acquired at substantially the same time as the image 302 to produce a respective set of annotated images 307. As a result, each annotated image 307 in the set may represent a single item associated with the inventory database 350.

In some other implementations, the data annotation component 314 may annotate multiple items as a group. For example, fruits or vegetables are often placed in plastic bags containing multiple items of the same type to be keyed in by the operator via the user interface 322. During this process, the cameras 330 may capture images 302 of a group of items (representing the object of interest) and the transaction processor 320 may concurrently acquire an inventory ID 305 (such as a PLU code) that is shared by every item in the group. The data annotation component 314 combines the images 302 with the inventory ID 305 acquired at substantially the same time as the images 302 to produce a respective set of annotated images 307. As a result, each annotated image 307 in the set may represent multiple items of the same type associated with the inventory database 350.

In some aspects, the CV interface 310 (or a separate machine learning system) may train the ML model 312 based on the annotated images 307. In some other aspects, the CV interface 310 may dynamically update the ML model 312 as new items are added to the inventory database 350. However, after the ML model 312 has been trained, the transaction processor 320 may rely on the CV interface 310 for determining the inventory IDs 305 of items in the sensing region 301. In some implementations, when the ML model 312 is unable to infer an inventory ID 305 for one or more items in the sensing region 301, the CV interface 310 may produce an inferencing result 303 indicating that the sensing region 301 contains one or more unknown items.

In response to receiving an inferencing result 303 indicating that the sensing region 301 contains one or more unknown items, the transaction processor 320 may prompt the operator of the POS system 300 to register the items in the sensing region 301 using one or more legacy POS technologies (such as via the user interface 322 or one or more legacy POS sensors 340). For example, the transaction processor 320 may display a message on the display 324 instructing the operator to scan the unknown item(s) using the barcode scanner 342 or enter an item code via the user interface 322. As described above, the data annotation component 314 may then annotate the images 302 of the unknown items based on an inventory ID 305 received from the transaction processor 320 (including sensor data 304 or user inputs 308 acquired via the barcode scanner 342 or the user interface 322).

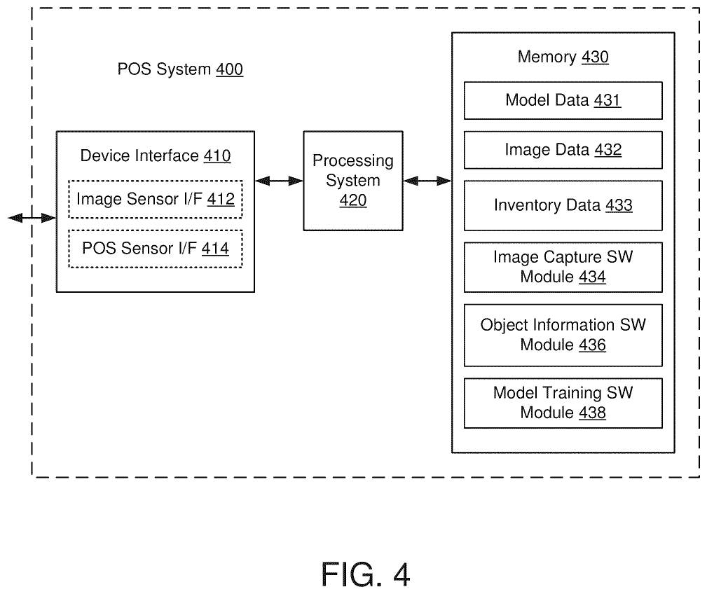

FIG. 4 shows another block diagram of an example point-of-sale (POS) system 400, according to some implementations. The POS system 400 may be configured to process transactions between a merchant and customer. Such transactions may include checking out items placed in a sensing region of a checkout counter (such as the sensing region 120 of FIG. 1). Further, the POS system 400 may be configured to train a computer vision model to classify objects in the sensing region. In some implementations, the POS system 400 may be one example of the POS system 110 of FIG. 1, the computer vision system 200 of FIG. 2, or the POS system 300 of FIG. 3. The POS system 400 includes a device interface 410, a processing system 420, and a memory 430.

The device interface 410 is configured to communicate with one or more components of one or more image capture devices (such as the camera(s) 140 of FIG. 1 or the image capture component 210 of FIG. 2) and one or more components of one or more POS sensors (such as the legacy POS sensors 340 of FIG. 3). In some implementations, the device interface 410 may include an image sensor interface (I/F) 412 configured to receive one or more images via the one or more image capture devices. In some implementations, the device interface 410 may include a POS sensor I/F 414 configured to receive sensor data via the one or more POS sensors.

The memory 430 may include a data store 431 configured to store one or more models for computer vision applications (e.g., object classification), a data store 432 configured to store one or more images and any associated annotations (e.g., annotated images), and a data store 433 for storing inventory data of objects (e.g., an inventory database). The memory 430 also may include a non-transitory computer-readable medium (including one or more nonvolatile memory elements, such as EPROM, EEPROM, Flash memory, or a hard drive, among other examples) that may store at least the following software (SW) modules:
an image capture SW module 434 to capture one or more images of an object via one or more image capture devices (e.g., cameras) each having a field of view (FOV) that encompasses the sensing region;
an object information SW module 436 to receive information about the object (e.g., from the inventory data store 433), the information including at least a price of the object; and
a model training SW module 438 to train a computer vision model (e.g., a model stored in data store 431) to classify objects in the sensing region based on the one or more images captured via the one or more cameras and the received information.

Each software module includes instructions that, when executed by the processing system 420, causes the POS system 400 to perform the corresponding functions.

The processing system 420 may include any suitable one or more processors capable of executing scripts or instructions of one or more software programs stored in the POS system 400 (such as in the memory 430). For example, the processing system 420 may execute the image capture SW module 434 to capture one or more images of an object in the sensing region, and may execute the object information SW module 436 to receive information about the object in the sensing region (e.g., obtain the information from the inventory data store 433).

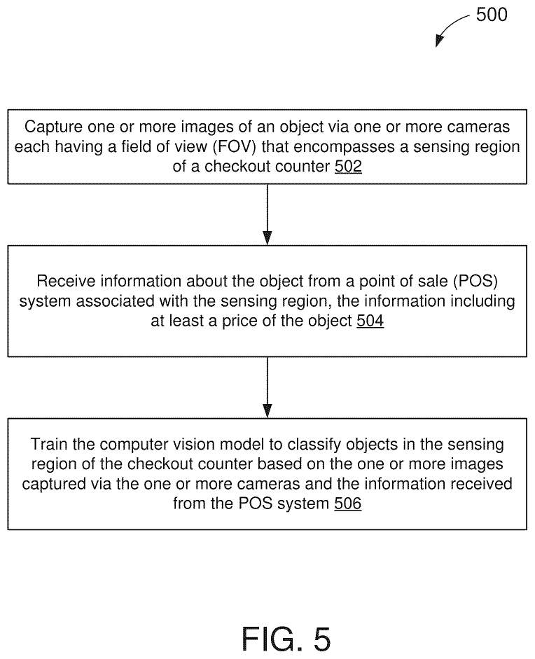

FIG. 5 shows an illustrative flowchart depicting an example operation 500 for training a computer vision model, according to some implementations. In some implementations, the example operation 500 may be performed by a computer vision system, such as the computer vision system 200 of FIG. 2.

The computer vision system may capture one or more images of an object via one or more cameras each having a field of view (FOV) that encompasses a sensing region of a checkout counter (502). The computer vision system may receive information about the object from a point of sale (POS) system associated with the sensing region, the information including at least a price of the object (504). The computer vision system may train a computer vision model to classify objects in the sensing region of the checkout counter based on the one or more images captured via the one or more cameras and the information received from the POS system (506).

In some aspects, the classifications represent purchasable items in an inventory database associated with the POS system.

In some aspects, the POS system includes a barcode scanner configured to scan barcodes printed or affixed on objects in the sensing region.

In some aspects, the information about the object further includes a Universal Product Code (UPC) acquired via the barcode scanner.

In some aspects, the POS system includes a scale configured to weigh objects in the sensing region.

In some aspects, the information about the object further includes a weight measured by the scale.

In some aspects, the information about the object further includes an item code input by a user of the POS system.

In some aspects, the item code comprises a Price Look Up (PLU) code.

In some aspects, the object includes a plurality of items having the same item code.

In some aspects, the computer vision system may annotate the one or more images based on the information about the object.

In some aspects, the one or more images are captured during a purchase transaction via the POS system.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for training a computer vision model, comprising:
capturing one or more images of an object via one or more cameras each having a field of view (FOV) that encompasses a sensing region of a checkout counter;
receiving information about the object from a point of sale (POS) system associated with the sensing region, the information including at least a price of the object; and
training the computer vision model to classify objects in the sensing region of the checkout counter based on the one or more images captured via the one or more cameras and the information received from the POS system.

2. The method of claim 1, wherein the classifications represent purchasable items in an inventory database associated with the POS system.

3. The method of claim 1, wherein the POS system includes a barcode scanner configured to scan barcodes printed or affixed on objects in the sensing region.

4. The method of claim 3, wherein the information about the object further includes a Universal Product Code (UPC) acquired via the barcode scanner.

5. The method of claim 1, wherein the POS system includes a scale configured to weigh objects in the sensing region.

6. The method of claim 5, wherein the information about the object further includes a weight measured by the scale.

7. The method of claim 1, wherein the information about the object further includes an item code input by a user of the POS system.

8. The method of claim 7, wherein the item code comprises a Price Look Up (PLU) code.

9. The method of claim 7, wherein the object includes a plurality of items having the same item code.

10. The method of claim 1, wherein the training of the computer vision model comprises:
annotating the one or more images based on the information about the object.

11. The method of claim 1, wherein the one or more images are captured during a purchase transaction via the POS system.

12. A computer vision system, comprising:
one or more cameras, each camera having a field of view (FOV) that encompasses a sensing region of a checkout counter;
one or more processors; and
a memory coupled to the one or more processors, the memory storing instructions that, when executed by the one or more processors, cause the computer vision system to:
capture one or more images of an object via the one or more cameras;
receive information about the object from a point of sale (POS) system associated with the sensing region, the information including at least a price of the object; and
train a computer vision model to classify objects in the sensing region of the checkout counter based on the one or more images captured via the one or more cameras and the information received from the POS system.

13. The computer vision system of claim 12, wherein the classifications represent purchasable items in an inventory database associated with the POS system.

14. The computer vision system of claim 12, wherein the POS system comprises a barcode scanner configured to scan barcodes printed or affixed on objects in the sensing region, and the information about the object further includes a Universal Product Code (UPC) acquired via the barcode scanner.

15. The computer vision system of claim 12, wherein the POS system comprises a scale configured to weigh objects in the sensing region, and the information about the object further includes a weight measured by the scale.

16. The computer vision system of claim 12, wherein the information about the object further includes an item code input by a user of the POS system.

17. The computer vision system of claim 16, wherein the item code comprises a Price Look Up (PLU) code.

18. The computer vision system of claim 16, wherein the object includes a plurality of items having the same item code.

19. The computer vision system of claim 12, wherein the memory further stores instructions that, when executed by the one or more processors, cause the POS system to:
annotate the one or more images based on the information about the object.

20. The computer vision system of claim 12, wherein the one or more images are captured during a purchase transaction via the POS system.
